(19) United States
(12) Patent Application Publication
(10) Pub. No.: US 2014/0299349 A1
(43) Pub. Date: Oct. 9, 2014

(54) HIGH-SPEED SIGNAL TRANSMISSION CABLE

(71) Applicant: TOTOKU ELECTRIC CO., LTD., Tokyo (JP)

(72) Inventors: Tadashi Yamaguchi, Nagano (JP); Shigehiro Sasai, Nagano (JP); Makoto Miyashita, Nagano (JP); Akihiro Sakaguchi, Nagano (JP); Shigeo Hayashi, Nagano (JP)

(73) Assignee: TOTOKU ELECTRIC CO., LTD., Tokyo (JP)

(21) Appl. No.: 14/352,163

(22) PCT Filed: Nov. 9, 2012
(86) PCT No.: PCT/JP2012/079068

§ 371 Date: Apr. 16, 2014

(30) Foreign Application Priority Data
Nov. 9, 2011 (JP) 2011-245344

(51) Int. Cl. H01B 11/20

(52) U.S. Cl. CPC H01B 11/20
USPC 174/107; 174/102 R

(57) ABSTRACT

A high-speed signal transmission cable includes a coaxial wire assembly, a shield layer arranged around an outer periphery of the coaxial wire assembly, and a sheath, arranged around as the outermost layer. Each coaxial wire includes an inner conductor, a hollow core member, and an outer conductor. The outer conductor is formed by longitudinally adding a metal foil or a plastic tape having a metal layer on an outer periphery of the hollow core member. The high-speed signal transmission cable can suitably transmit a high-speed digital signal of 10 Gbps and above, and its characteristics do not degrade easily even if it is used on multiple cores twist structure or bending. Therefore, the high-speed signal transmission cable can be used in environments that require high-speed transmission of digital signals.

### TECHNICAL FIELD

The present invention relates to high-speed signal transmission cables. More particularly, the present invention relates to a high-speed signal transmission cable that can suitably transmit a high-speed digital signal of 10 Gbps and above, and whose characteristics do not easily degrade even by using on multiple cores twist structure or bending.

### BACKGROUND ART

A signal cable is known in the art in which two coaxial cables are used as a coaxial cable pair and an outer surface of the coaxial cable pair is covered with a whole shielding layer. In such a signal cable, each outer conductor of each of the coaxial cables is formed with a braided conductor (See, for example, Patent Document 1).

Moreover, a digital signal differential transmission cable is known in the art in which two coaxial cables are used as a coaxial cable pair, plural such coaxial cable pairs are arranged on concentric circles, and an outer surface of this assembly is covered with a whole shielding layer. In such a digital signal differential transmission cable, an individual outer conductor of each of the coaxial cables is formed by lateral winding (See, for example, Patent Document 2).

Moreover, a high-speed differential transmission cable is known in the art in which a signal wire is formed by arranging, around an outer periphery of an inner conductor (central conductor), a hollow insulating member having hollow portions extending in a longitudinal direction thereof, two such signal wires and a drain wire are arranged, and an outer surface of this assembly is covered with an outer conductor. In such a high-speed differential transmission cable, the outer conductor is formed by winding or longitudinally adding a metal tape (See, for example, Patent Document 3).

### CONVENTIONAL ART DOCUMENTS

Patent Document

Patent Document 1: Japanese Patent Application Laid-open No. SHO60-101808

Patent Document 2: Japanese Patent No. 4110382

Patent Document 3: Japanese Patent No. 4685744

### SUMMARY OF THE INVENTION

### Problems to be Solved by the Invention

The signal cable disclosed in Patent Document 1 has the following drawbacks. Because a solid member is used as an insulating member of each of the coaxial cables, the dielectric constant of the coaxial cable is high (higher the dielectric constant, slower the transmission speed, and higher the loss). Because the each outer conductor of each of the coaxial cables is formed with a braided conductor, the inner surface of the outer conductor is far from smooth. Moreover, because a braided structure has been employed, wires of the outer conductor are longer than a single conductor whereby the electric resistance of the outer conductor becomes higher than the same of the single conductor and losses increase in the frequency band for transmitting a high-speed digital, signal of 10 Gbps and above. Moreover, in the outer conductor formed with the braided conductor, vacant spaces produced between the wires and the surface of the insulating member are not uniform owing to the braided structure of the wires. Accordingly, the dielectric constant tends to easily fluctuate along the longitudinal direction of the insulating member, resulting in a large fluctuation in an electric length when even a physical length is made constant. Furthermore, as the adherence between the braided conductor and the insulating member is not satisfactory, a state of contact between the braided conductor and the insulating member changes when the cable is used on multiple cores twist structure or bent, leading to variation in the dielectric constant. Particularly, when two of signal cables are taken as a cable pair and differential signals are transmitted through them at a high speed such that the phases of the transmitted signals are opposite, the signal transmission speed varies between the two signal cables and a transmission characteristics becomes worse.

The digital signal differential transmission cable disclosed in Patent Document 2 has the following drawbacks. Because a solid member is used as an insulating member of each of the coaxial, cables, the dielectric constant of the coaxial cable becomes high. Moreover, because an each, outer conductor of each of the coaxial cables is formed, by lateral winding (in a shield structure formed by winding plural parallel, arranged small-diameter annealed copper wires, etc., at a definite pitch around a periphery of an insulating resin layer without gaps, the each outer conductor is longer than the central conductor), the structure of the outer conductor easily loses its shape when the cable is used on multiple cores twist structure or bent. Due to this, a contact resistance becomes unstable and a electrical resistance becomes higher. Accordingly, losses increase in the frequency band for transmitting a high-speed, digital signal of 10 Gbps and above. Moreover, in the outer conductor that is formed by lateral winding, vacant spaces produced between the wires and the surface of the insulating member are not uniform due to the pitch-wound structure of the wires. Accordingly, because the characteristic impedance between the central conductor and the each outer conductor as a transmission path does not remain constant, the dielectric constant tends to vary along the longitudinal direction of the insulating member, resulting in a large variation in the electric length when even the physical length of the cable is made constant. Furthermore, as the state of contact between the wires and the insulating resin layer changes due to losing of the shape of the outer conductor structure, the dielectric constant, tends to vary easily. Particularly, when two of signal cables are taken as a cable pair and differential signals are transmitted through them at a high speed such that the phases of the transmitted signals are opposite, the signal transmission speed varies between the two cables and a transmission characteristics becomes worse.

The high-speed differential transmission cable disclosed in Patent Document 3 has the following drawbacks. When the cable is used on multiple cores twist structure or bent, the shape of the vacant space between the hollow core member and the outer conductor tends to vary easily. When the shape of the vacant space varies, the dimensions of the vacant space touching the insulating cover layer of the signal wires in which two cores are arranged parallel changes greatly, Accordingly, the signal transmission speed varies between the two signal wires and a transmission characteristics becomes worse.

Furthermore, in a 6-Gbps digital differential transmission, for a transmission cable, it is required that the intra-pair skew is less than 20 ps/m and. the inter-pair skew is less than 40 ps/m. Accordingly, in a transmission of 10-Gbps and above, it is required that the intra-pair skew is less than 10 ps/m and the inter-pair skew is less than 20 ps/m.

In view of the above discussion, it is an object of the present invention to provide a high-speed signal transmission cable that can suitably transmit a high-speed digital signal of 10 Gbps and above, and whose signal transmission speed is constant and the characteristics do not degrade when the cable is used on multiple cores twist structure or bent, and the electric length of each of the cables does not fluctuate much.

### Means to Solve the Problems

A high-speed signal transmission cable (101, 102) according to a first aspect of the present invention includes a coaxial wire assembly (10) formed by bunching plural coaxial wires (11) and holding them together by winding a tape (12) around their outer periphery, a shield layer (13) arranged around, an outer periphery of the coaxial wire assembly (10), and a sheath (14) arranged as an outermost layer, wherein the coaxial wire (11) includes an inner conductor (1), a hollow core member (2) including an inner annular member (2a) that covers the inner conductor (1), plural rib members (2b) that radially extend from the inner annular member (2a), an outer annular member (2c) that couples outer ends of the rib members (2b), and plural hollow members (2d) that are enclosed by the inner annular member (2a), the rib members (2b), and the outer annular member (2c), and an outer conductor (3) formed by longitudinally adding a metal foil or a plastic tape having a metal layer on one or both of its surfaces on an outer periphery of the hollow core member (2) such that at least an outer surface of the plastic tape is a metal surface.

In the high-speed signal transmission cable (101, 102) according to the first aspect, because of the following reasons, the loss in a frequency band for high-speed digital signal transmission of 10 Gbps and above is reduced so that a high-speed digital signal of 10 Gbps and above can be suitably transmitted. That is, because the hollow core member (2) is used as an insulating member of each of the coaxial wires (11) (because the dielectric constant of the hollow core member is lower than the same of a solid type insulating member, a high-speed digital signal of 10 Gbps and above can be suitably transmitted, and because air layers are stably present along a longitudinal direction of the hollow core member, the dielectric constant is maintained uniform along the longitudinal direction of the coaxial wire as compared to a case where a foam type insulating member in which it is difficult to form a foam uniformly inside the insulating member), because each of the coaxial wires (11) separately includes the outer conductor (3) (no change in the dielectric constant due to presence of vacant spaces as there is no vacant space between the hollow core member and the outer conductor), and because the outer conductor (3) is formed by longitudinally adding a metal foil or a plastic tape having a metal layer (the electric resistance reduces as compared to a braided conductor or a spiral winding with a metal foil and the like because the outer conductor structure becomes stable and the current path becomes shortest). Moreover, because no vacant space is produced between the hollow core member and the outer conductor even when it is used on multiple cores twist structure or bending, the change in the dielectric constant is small (although there may be slight change due to a deformation of the air layer of the hollow core member) and the transmission characteristics do not degrade easily. In the steps for processing the high-speed signal transmission cable, such as a step for passing through a die when performing longitudinal adding of the outer conductor (3), and a step of bunching the coaxial wires (11) and winding the tape (12) around the outer periphery thereof to hold them together, a lateral pressure is exerted on the insulating member. The dielectric constant of the conventional foam type insulating member changes due to collapse of the insulating member when the lateral pressure is exerted. In contrast, because the hollow core member has excellent lateral pressure strength (disclosed in Japanese Patent Application Laid-open No. 2011-023205), even if the processing in which the lateral pressure is exerted is performed, the change in the dielectric constant due to the collapse is small.

In the high-speed signal transmission cable, a signal can be transmitted in a single coaxial wire, or differential signals can be transmitted in two desired coaxial wires taken as a pair such that the phases of the signals are opposite. In the signal transmission cable that, uses the coaxial cable having the conventional foam type insulating member, the electric length fluctuates if simply the physical lengths of the cables are matched. Accordingly, conventionally, it is necessary that the electric length of each of the cables is measured, the measured electric length is converted into the physical length, and two cables are made a pair only after performing adjustment for matching their electric lengths by the additional physical length processing. In contrast, in the high-speed signal transmission cable according to the present invention, because the dielectric constant of the insulating member is uniform in the longitudinal direction due to the hollow core member (2) of the coaxial wire (11), and the outer conductor (3) is formed by longitudinally adding a metal foil or a plastic tape having a metal layer, its dielectric constant does not change as there is no vacant space between the insulating member and the outer conductor. Therefore, the electric lengths of the coaxial wires can be matched by simply matching the physical length of each of the coaxial wires (11). Accordingly, in actual use, i.e., harness-shape where a connector board is connected to both the ends of the cable, when, connecting the cable conductor to a connecting pad of a board, because the electric lengths of all the coaxial wires inside the cable are matching (have equal electric lengths), there is no problem even if a desired one of the coaxial wires is connected to a desired one of the pads. Accordingly, the connector workability improves drastically, and is particularly superior when cable processing of differential structure that involves a drain wire is performed.

Wasted spaces are undesirably produced when a high-speed signal transmission cable is formed by bunching plural high-speed differential transmission cables of Patent Document 3 that have substantially elliptical cross-sections and integrating them by covering all of them with an outer conductor and a sheath and the like, and the cable diameter becomes large. In contrast, because the high-speed signal transmission cable according so the first aspect has a structure in which plural coaxial wires having substantially circular cross-section are bunched and a tape is wound around their outer periphery to hold them together, the coaxial wires can be arranged so that no wasted space is produced. Accordingly, the cable diameter can be made small, and the flexibility of the cable improves dramatically.

In a high-speed signal transmission cable (201, 202) according to a second aspect of the present invention, in the high-speed signal transmission cable according to the first aspect, at least an outer surface of the outer conductor (3) is a metal surface, and a braided conductor (4) is arranged on an outer periphery of the outer conductor (3).

In the high-speed signal transmission cable according to the second aspect, even if the metal foil or the plastic tape having a metal layer that functions as the outer conductor (3) is partially damaged due to bending of the cable, the braided conductor (4) functions as a current path in the damaged part enabling suppressing of degradation of the characteristics.

### Advantages of the Invention

The high-speed signal transmission cable according to the present invention can suitably transmit a high-speed digital signal of 10 Gbps and above, and its transmission characteristics are less sensitive to the installation conditions.

### BRIEF DESCRIPTION OF THE DRAWINGS

FIG. 1 is a cross-sectional view of a high-speed signal transmission cable according to a first embodiment;

FIG. 2 is a perspective view of a coaxial wire according to the first embodiment;

FIG. 3 is a cross-sectional view of a high-speed signal transmission cable according to a second embodiment;

FIG. 4 is a cross-sectional view of a high-speed signal transmission cable according to a third embodiment;

FIG. 5 is a perspective view of a coaxial wire according to the third embodiment;

FIG. 6 is a cross-sectional view of a high-speed signal transmission cable according to a fourth embodiment;

FIG. 7 is a graph showing the characteristics of the high-speed signal transmission cable according to the fourth embodiment and the characteristics of cables of comparative, examples 1 and 2;

FIG. 8 is a table showing the characteristics of the high-speed signal transmission cable according to the first embodiment and the characteristics of cables of comparative examples 4 and 5; and

FIG. 9 is a table that shows the result of measurement of a variation amount of an electric length (delay time per 1 meter of a cable) when a bending stress is applied on the coaxial wire used in the high-speed signal transmission cable employed in FIG. 8.

### EMBODIMENTS OF THE INVENTION

The present invention will be explained in more detail below with reference to the exemplary embodiments shown in the accompanying drawings. However, the present invention is not limited to the embodiments explained below.

### Embodiments

### First Embodiment

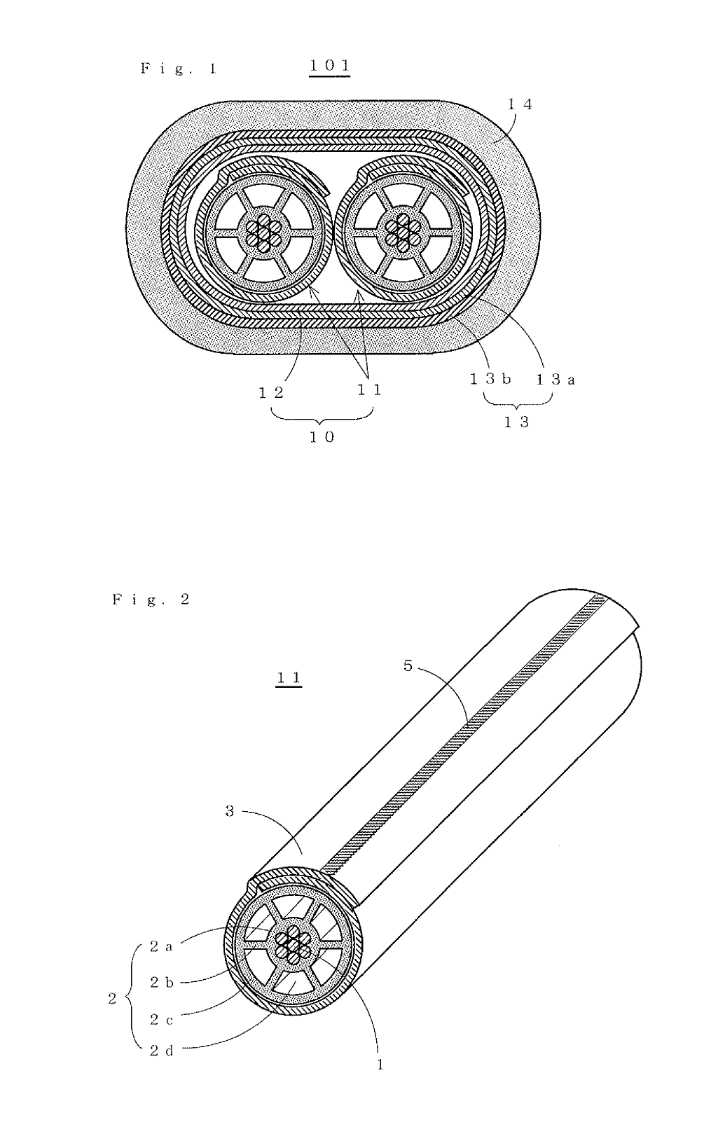

FIG. 1 is a cross-sectional view of a high-speed signal transmission cable 101 according to a first embodiment.

This high-speed signal transmission cable 101 includes a coaxial wire assembly 10, a shield layer 13, and a sheath 14. The coaxial wire assembly 10 includes two coaxial wires 11 bunched by twisting or arranging parallel, and a tape 12 that is wound around an outer periphery of the coaxial wires 11 to hold them together. The shield layer 13 is arranged around an outer periphery of the coaxial wire assembly 10, and includes a first shield 13a and a second shield 13b. The sheath 14 is arranged as the outermost layer of the high-speed signal transmission cable 101.

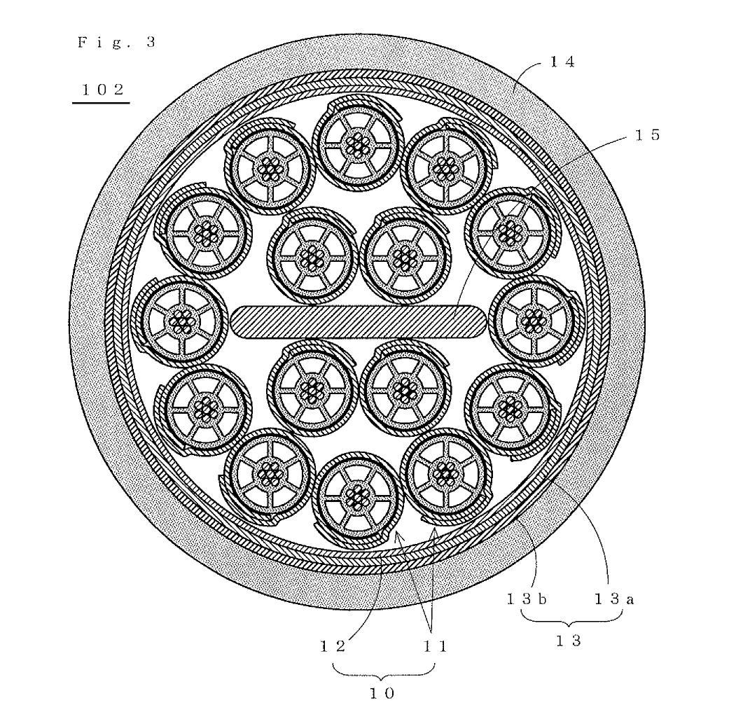

FIG. 2 is a perspective view of the coaxial wire 11.

The coaxial wire 11 includes an inner conductor 1, a hollow core member 2, and an outer conductor 3. The hollow core member 2 includes an inner annular member 2a that covers the inner conductor 1, plural rib members 2b that radially extend from the inner annular member 2a, an outer annular member 2c that couples outer ends of the rib members 2b, and plural hollow members 2d that are enclosed by the inner annular member 2a, the outer annular member 2b, and the rib members 2c The outer conductor 3 is a plastic tape having a metal layer and longitudinally added on an outer periphery of the hollow core member 2.

The outer diameter of the coaxial wire 11 is, for example, 0.98 millimeter (mm).

A separate insulating cover layer can be arranged around an outer periphery of each of the coaxial wires 11.

The inner conductor 1 is a bunched twisted conductor formed by, for example, bunching and twisting seven tin-plated annealed copper wires of diameter 0.127 mm. However, the inner conductor 1 can be a single wire. Alternatively, the inner conductor 1 can be a concentrically laid twisted wires. Moreover, the inner conductor 1 can be a copper alloy wire, or any other plated wire.

The hollow core member 2 can be made of, for example, PFA, and has an outer diameter of, for example, 0.95 mm. Other than PFA, the hollow core member 2 can be made of a fluororesin such as FFP, PTFF, and ETFE. Alternatively, the hollow core member 2 can be made of a polyolefin resin such as PE and PP.

In order to ensure sufficient mechanical, strength, it is preferable that the rib members 2b are three or more in number.

The hollowness of the hollow members 2d with respect to the entire volume of the hollow core member 2 is, for example, between 20% and 70%.

The outer conductor 3 is, for example, a copper-plated polyester tape with an outer surface plated with copper and an inner surface applied with an adhesive. The outer conductor 3 is longitudinally added around and adhered to an outer periphery of the hollow core member 2 such that there is an overlap of about 25% of the tape width. Other than a metal-plated plastic tape or a metal foil, the outer conductor 3 can be a metal-laminated plastic tape, or a metal vapor-deposited plastic tape. Other than copper, the metal can be gold, silver, aluminum and the like. When an insulating cover layer and the like is provided around an outer periphery of the outer conductor 3, the adhesive may not be applied on the inner surface of the outer conductor 3.

A thickness of the outer conductor 3 is, for example, between 0.005 mm and 0.050 mm.

A marking 5 can be provided on an outer surface of the outer conductor 3. Providing a marking of different colors on different coaxial wires 11 facilitates recognition of the coaxial wires 11. Alternatively, an insulating cover layer that facilitates recognition can be provided around an outer periphery of the outer conductor 3 of each of the coaxial wires.

Returning to FIG. 1, the tape 12 is, for example, a polyester tape.

The first shield 13a is, for example, an aluminized polyester tape.

The second shield 13b is, for example, a braided conductor formed by braiding tin-plated annealed copper wires.

The sheath 14 is made from, for example, lead-free PVC.

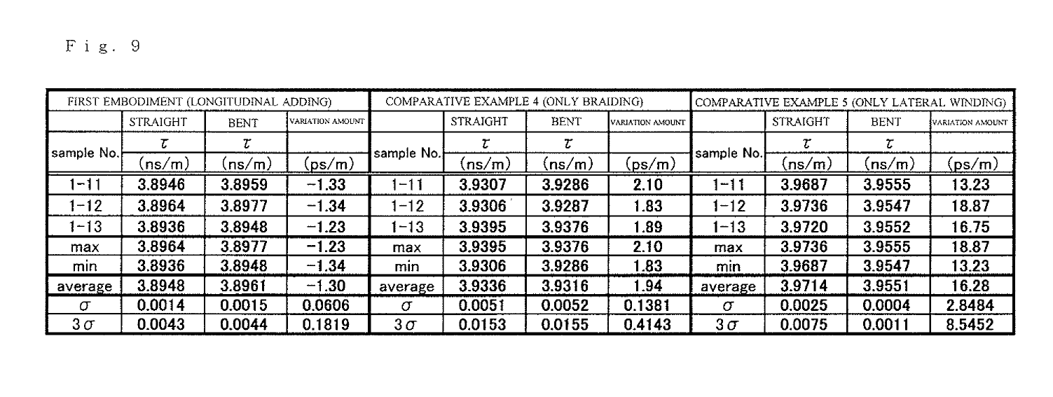

FIG. 8 is a table showing measurement results of electric lengths (delay time per 1 meter of a cable) τ of 16 samples of the coaxial wires 11 used in the high-speed signal transmission cable 101.

In the table of FIG. 8, “max” represents a maximum value of the measured values, “min” represents a minimum value of the measured values, “max-min” represents a delay time difference, “average” represents an average value, a represents a standard deviation, and 3σ represents three times of the standard deviation.

### First Embodiment

The coaxial wire 11 including an insulating cable of the first embodiment was prepared as follows. The insulating cable includes an inner conductor and a hollow core member arranged around an outer periphery of the inner conductor. The inner conductor is formed by twisting seven tin-plated annealed copper wires (28 AWG) of diameter 0.127 mm. The hollow core member, as the insulating member, is made from PFA, with an outer diameter 0.95 mm and hollowness 55%, The insulating cable was shielded by longitudinally adding a 0.015-mm thick copper laminated plastic tape, and an outer periphery of the entire assembly was covered with FEP to obtain the coaxial wire 11.

### Comparative Example 4

Silver-plated annealed copper wires of diameter 0.05 mm were braided, as the outer conductor, around the insulating cable of the first embodiment to obtain a coaxial wire of a comparative example 4.

### Comparative Example 5

A silver-plated annealed copper wire of diameter 0.08 mm was laterally wound, as the outer conductor, around the insulating cable of the first embodiment to obtain a coaxial wire of a comparative example 5.

Characteristic impedance of each of the coaxial wires of the first embodiment and the comparative examples 4 and 5 was set to 51±1 ohm (Ω).

The delay time difference of the coaxial wire 11 used in the first embodiment 1 was 4.1 ps/m. It is clear that the delay time difference of the cable of the first embodiment 1 is smaller than the same of the comparative examples 4 and 5 when their physical lengths are matched.

FIG. 9 is a table that shows the result of measurement of a variation amount of an electric length (delay time τ per 1 meter of a cable) when a bending stress is applied on the coaxial wire 11 used in the high-speed signal transmission cable 101 of FIG. 8.

Concretely, three samples of each of the coaxial wires of the first embodiment and the comparative examples 4 and 5 were prepared, and their delay times τ before applying a stress on them were measured. Then, delay times τ after winding three turns around a cylinder of a diameter 70 mm were measured, and the variation amounts of the delay times were compared.

An average value of the variation amounts of the delay times τ of the coaxial wire 11 used in the first embodiment was −1.30 ps/m. This variation can be attributed to a small increase in the dielectric constant of the insulating member due to a deformation (collapse) of air layers in the hollow core member.

An average value of the variation amounts of the delay times τ of the coaxial wires (braided outer conductor) used in the comparative example 4 was 1.94 ps/m. This variation can be attributed to the same deformation of the similar hollow core member as that in the first embodiment, but more than that, to a decrease in the combined dielectric constant of the insulating members due to a change in a state of contact between the braided conductors of the outer conductor and the insulating members. When compared with the first embodiment, although the difference in the average values of the variation amounts of the delay times x due to application of bending stress is small, with respect to a fluctuation in the variation amount, σ is 0.0606 in the first embodiment while it is 0.1381 in the comparative example 4. That is, the fluctuation in the comparative example 4 is 2.28 times of the same in the first embodiment. Accordingly, if the high-speed signal transmission cable is bent when performing wiring, the delay time τ of each of the coaxial wires inside the cable fluctuates greatly, leading particularly to a degradation in the transmission characteristics of the differential signals.

An average value of the variation amounts of the delay times τ of the coaxial wires (lateral wound outer conductor) used in the comparative example 5 was 16.28 ps/m. This variation can be attributed to the same deformation of the similar hollow core member as that in the first embodiment, but more than that, to a decrease in a combined dielectric constant of the insulating members due to a large change in a state of contact between the lateral-wound shield of the outer conductor and the insulating members. Because the variation amount crossed 10 ps/m, the coaxial wires of the comparative example 5 cannot be used in the high-speed signal transmission of 10 Gbps and above.

The high-speed signal transmission cable 101 according to the first embodiment has the following advantages.

(1) Because the hollow core member 2 is used as the insulating member of each of the coaxial wires 11, it is possible to reduce the dielectric constant as compared to a case when the insulating member is solid type, and the dielectric constant becomes uniform in the direction of the concentric circles as well as in the longitudinal direction as compared to a case when the insulating member is foam type. Therefore, the high-speed signal transmission cable 101 according to the first embodiment is suited for high-speed signal transmission. Moreover, because each of the coaxial wires 11 respectively includes the outer conductor 3, no vacant space is produced between the hollow core member and the outer conductor, whereby the dielectric constant of the high-speed signal transmission cable 101 does not vary. Furthermore, because the outer conductor 3 is formed by longitudinally adding a metal foil or a plastic tape having a metal layer, the inner surface of the outer conductor becomes smooth, and a current path becomes shortest, and the variation amount of the delay time when a bending stress is applied and the fluctuation of the variation amount become small. Accordingly, high-speed digital differential signals of 10 Gbps and above can be suitably transmitted for a length of approximately 5 meters (m), and the transmission characteristics do not change much even when a bending stress is applied during terminal processing or installation of the high-speed signal transmission cable.

(2) Because the electric lengths of each of the coaxial wires 11 can be matched by simply matching their physical lengths, steps for measuring the electric length of each of the coaxial wires, converting the measured electric lengths into the physical lengths, and performing additional processing for adjusting the physical lengths to match the electric lengths become unnecessary.

(3) In order to make the difference between the delay times among the coaxial wires as small as possible, one approach is, for example, to measure the electric length of each of the coaxial wires, convert the measured electric length into the physical length, and adjust the physical length to match the electric length by performing additional processing. However, because the fluctuation in the electric length of each of the coaxial wires is originally small in the high-speed signal transmission cable 101, the additional processing is easy to realize as the physical lengths that need to be adjusted are small.

(4) Because there is no vacant space between the hollow core member and the outer conductor even when it is used on multiple cores twist structure or bending, the variation in the dielectric constant is small, and the transmission characteristics do not degrade easily as the electric length does not change.

(5) The marking 5 on the outer surface of each of the coaxial wires 11, or the insulating cover layer facilitates visual recognition of each of the coaxial wires 11.

### Second Embodiment

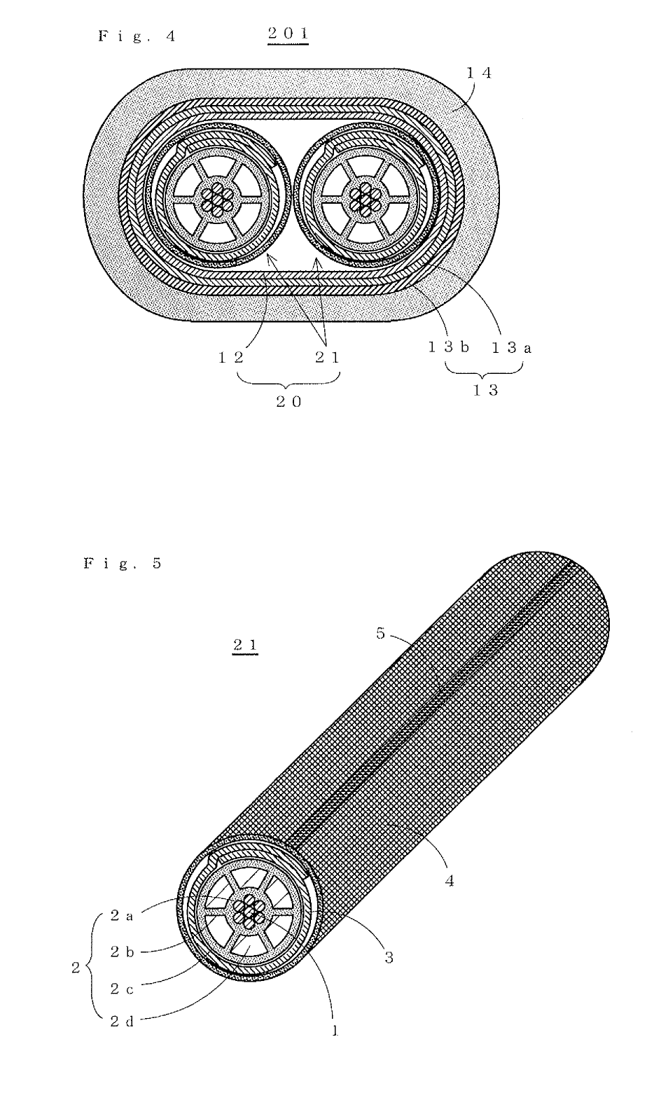

FIG. 3 is a cross-sectional view of a high-speed signal transmission cable 102 according to a second embodiment.

The high-speed signal transmission cable 102 includes the coaxial wire assembly 10, the shield layer 13, and the sheath 14, The coaxial wire assembly 10 includes an intervention 15 of suitable shape and size and made of a flexible resin material, 16 units of the coaxial wires 11 bunched by twisting or arranging parallel, and the tape 12 wound around an outer periphery of the coaxial wires 11 so as to hold them together. The shield layer 13 is arranged around, an outer periphery of the coaxial wire assembly 10, and includes the first shield 13a and the second shield 13b, The sheath 14 is arranged as the outermost layer.

The. coaxial wire 11, the tape 12, the first, shield 13a, the second shield 13b, and the sheath 14 are the same as that in the first embodiment. That is, the sheath 14 of thickness 0.85 mm is used, so that, the final product has an outer diameter of 8.5 mm.

The high-speed signal, transmission cable 102 according to the second embodiment has the same advantages as that of the first embodiment.

When two desired coaxial wires are taken as a cable pair and differential signals are transmitted through them such that the phases of the transmitted signals are opposite, because the electric lengths of all the coaxial wires inside the cable match, and because each of the coaxial wires is completely shielded by longitudinally adding a metal foil or a plastic tape having a metal layer, the delay time difference can be reduced to 4.1 ps/m as shown in FIG. 8 even if any two coaxial wires are paired,

### Third Embodiment

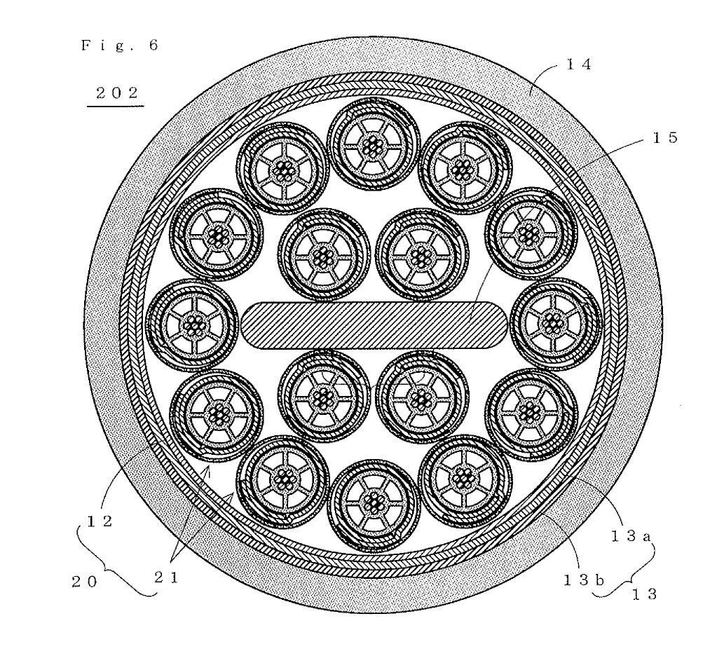

FIG. 4 is a cross-sectional view of a high-speed signal transmission cable 201 according to a third embodiment.

The high-speed signal transmission cable 201 includes a coaxial wire assembly 20, the shield layer 13, and the sheath 14. The coaxial wire assembly 20 includes two coaxial wires 21 bunched, by twisting or arranging parallel, and the tape 12 that is wound around an outer periphery of the coaxial wires 21 to hold them together. The shield layer 13 is arranged around an outer periphery of the coaxial wire assembly 20, and includes the first shield 13a and the second shield 13b, The sheath 14 is arranged as the outermost layer.

The tape 12, the first shield 13a, the second shield 13b, and the sheath 14 are the same as that in the first embodiment.

FIG. 5 is a perspective view of the coaxial wire 21.

The coaxial wire 21 includes the inner conductor 1, the hollow core member 2, the outer conductor 3, and a braided conductor 4. The hollow core member 2 includes the inner annular member 2a that covers the inner conductor 1, plural rib members 2b that radially extend from the inner annular member 2a, the outer annular member 2c that couples the outer ends of the rib members 2b, and plural hollow members 2d that are enclosed by the inner annular member 2a, the outer annular member 2b, and the rib members 2c. The outer conductor 3 is a plastic tape that has a metal layer at least on its outer surface and that is longitudinally added around an outer periphery of the hollow core member 2. The braided conductor 4 is arranged around an outer periphery of the outer conductor 3.

The inner conductor 1, the hollow core member 2, and the outer conductor 3 are the same as that in the first embodiment.

The braided conductor 4 is made of, for example, tin-plated annealed copper wires. The braided conductor 4 is in electrical contact with an outer surface of the outer conductor 3.

Because marking cannot be done directly on a braided conductor, changing the material of one or more of the braided wires can facilitate recognition of the braided conductor. Alternatively, an insulating cover layer that facilitates recognition can be additionally arranged around an outer periphery of the braided conductor 4 of each of the coaxial wires.

According to the high-speed signal transmission cable 201 of the third embodiment, in addition to the advantages of the first embodiment, even if the plastic tape that functions as the outer conductor 3 is partially damaged due to bending of the cable, the braided conductor 4 functions as a current path in the damaged part enabling suppressing of degradation of the characteristics.

### Fourth Embodiment

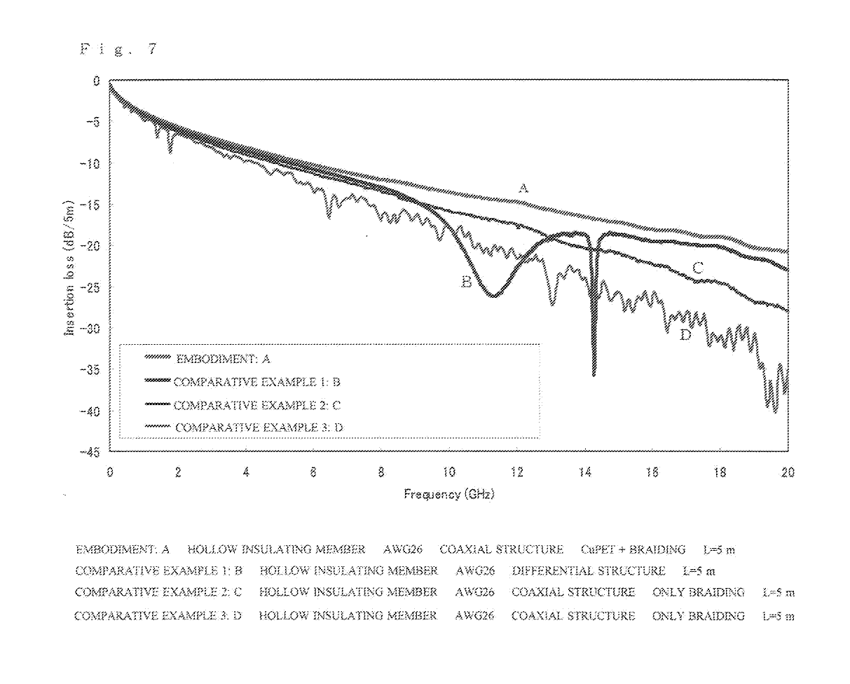

FIG. 6 is a cross-sectional view of a high-speed signal transmission cable 202 according to a fourth embodiment.

The high-speed signal transmission cable 202 includes the coaxial wire assembly 20, the shield layer 13, and the sheath 14, The coaxial wire assembly 20 includes the intervention 15 of suitable shape and size and made of a flexible resin material, 16 units of the coaxial wires 21 bunched by twisting or arranging parallel, and the tape 12 wound around an outer periphery of the coaxial wires 21 so as to hold them together. The shield layer 13 is arranged around an outer periphery of the coaxial wire assembly 20, and includes the first shield 13a and the second shield 13b. The sheath 14 is arranged as the outermost layer.

The coaxial wires 21 are the same as that, in the third embodiment, The tape 12, the first shield 13a, the second shield 13b, and the sheath 14 are the same as that in the first embodiment.

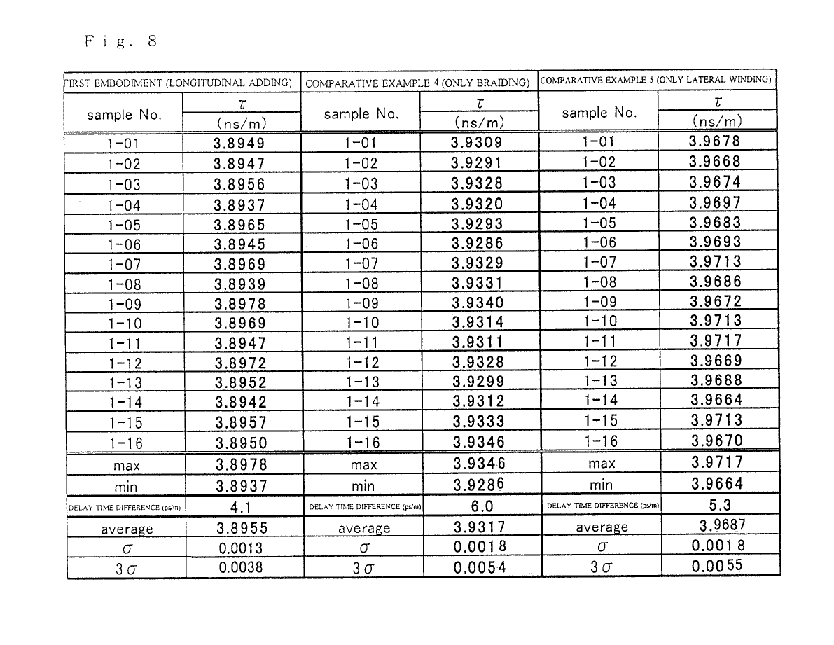

A characteristic curve A (embodiment) shown in FIG. 7 represents the attenuation amounts when differential signals were transmitted for a length of 5 m through a pair of the coaxial wires 21 of the high-speed signal transmission cable 202.

A characteristic curve B (comparative example 1) shown in FIG. 7 represents the attenuation amounts when differential signals were transmitted for a length of 5 m through a high-speed differential transmission cable (See, FIG. 1 of Patent Document 3) having a configuration as explained below. That is, a signal wire is formed by arranging a hollow core member around an outer-periphery of an inner conductor (the same hollow core member as that used in the coaxial wires 21 was used). Two such signal wires and a drain wire were arranged parallel, and an entire outer surface of this assembly was covered with an outer conductor to obtain the high-speed differential transmission cable.

A characteristic curve C (comparative example 2) shown in FIG. 7 represents the attenuation amounts when differential signals were transmitted for a length of 5 m through a pair of the coaxial wires 21 of the high-speed signal transmission cable 202; however, the outer conductor 3 (which is formed by longitudinally adding a metal foil or a plastic tape having a metal layer) was not arranged in the coaxial wires 21.

A characteristic curve D (comparative example 3) shown in FIG. 7 represents the attenuation amounts when differential signals were transmitted for a length of 5 m through a pair of the coaxial wires 21 of the high-speed signal transmission cable 202; however, the outer conductors of the coaxial wires 21 were formed with only a laterally wound shield.

The comparative example 1 exhibited a phenomenon called suck-out in which there is an extraordinarily large loss in a specific frequency range. As a result, the cable of the comparative example 1 cannot be used in high-speed signal transmission of 6 GHz and above.

The comparative example 2 exhibits a gentle attenuation curve; however, an increase in the electric resistance of the outer conductor, in comparison with that of the embodiment, because the outer conductor of the comparative example 2 is formed by the braided conductor, has appeared as a larger attenuation amount in the graph. The difference in the attenuation amounts between the embodiment and the comparative example 2 increases after 6 GHz, and the difference is approximately 3 dB at 12 GHz. The attenuation amount increases further as the frequency increases.

The attenuation curve of the comparative example 3 shows drastic fluctuations. The drastic fluctuations of the attenuation characteristics appear in the curve due to the fact that, as the outer conductor is formed by the lateral winding, the characteristic, impedance between the central conductor as the transmission path and the outer conductor does not remain constant because of the presence of vacant spaces between the wires and the surface of the insulating member owing to a pitch-wound structure of the wires. Moreover, because the coaxial wire is formed by the lateral winding, the attenuation amount is large as the electric resistance of the outer conductor is large as compared to the comparative examples 1 and 2.

When the embodiment and comparative examples are compared, the attenuation amount of the high-speed signal transmission cable 202 according to the embodiment is minimum when the frequency is 6 GHz and above.

The high-speed signal, transmission cable 202 according to the fourth embodiment has the same advantages as that of the first embodiment to the third embodiment.

### INDUSTRIAL APPLICABILITY

The high-speed signal transmission cable according to the present invention can be used in high-speed transmission of digital signals.

### DESCRIPTION OF REFERENCE NUMERALS

1 Inner conductor
2 Hollow core member
2a Inner annular member
2b Rib member
2c Outer annular member
2d Hollow member
3 Outer conductor
4 Braided conductor
10, 20 Coaxial wire assembly

1. A high-speed signal transmission cable including a coaxial wire assembly formed by bunching plural coaxial wires and holding them together by winding a tape around an outer periphery thereof a shield layer arranged around an outer periphery of the coaxial wire assembly, and a sheath arranged as an outermost layer, wherein
the coaxial wire comprises:
an inner conductor,
a hollow core member including an inner annular member that covers the inner conductor, plural rib members that radially extend from the inner annular member, an outer annular member that couples outer ends of the rib members, and plural hollow members that are enclosed by the inner annular member, the rib members, and the outer annular member, and
an outer conductor formed by longitudinally adding a metal foil or a plastic tape having a metal layer on one or both surfaces thereof on an outer periphery of the hollow core member such that at least an outer surface of the plastic tape is a metal surface.

2. The high-speed signal transmission cable according to claim 1, wherein
at least an outer surface of the outer conductor is a metal surface, and
a braided conductor is arranged around an outer periphery of the outer conductor.

3. In a high-speed signal transmission cable having a coaxial wire which comprises:
an inner conductor,
a hollow core member including an inner annular member that covers the inner conductor, plural rib members that radially extend from the inner annular member, an outer annular member that couples outer ends of the rib members, and plural hollow members that are enclosed by the inner annular member, the rib members, and the outer annular member, and
an outer conductor formed by longitudinally adding a metal foil or a plastic tape having a metal layer on one or both surfaces thereof on an outer periphery of the hollow core member such that at least an outer surface of the plastic tape is a metal surface.
